(19) United States
(12) Patent Application Publication
(10) Pub. No.: US 2023/0311211 A1
(43) Pub. Date: Oct. 5, 2023

(54) POWDER METAL MATERIAL FOR ADDITIVE MANUFACTURING WHICH IS ALUMINUM ALLOY AND ADDITIVE MANUFACTURING METHOD

(71) Applicant: HONDA MOTOR CO., LTD., Tokyo (JP)

(72) Inventors: Hiroyuki WATANABE, Saitama (JP); Kazuo KIKAWA, Saitama (JP)

(73) Assignee: HONDA MOTOR CO., LTD., Tokyo (JP)

(21) Appl. No.: 18/123,697

(22) Filed: Mar. 20, 2023

(30) Foreign Application Priority Data
Mar. 31, 2022 (JP) 2022-060242

(51) Int. Cl. B22F 10/28; C22C 21/00; C22C 21/02; C22C 1/04

(52) U.S. Cl. CPC B22F 10/28; C22C 21/003; C22C 21/02; C22C 1/0416; B22F 2301/052; B33Y 10/00

(57) ABSTRACT

A powder metal material in order to be used in additive manufacturing, in which the powder metal material is an aluminum alloy, and the aluminum alloy contains at least one metal atom having a smaller atomic radius than that of aluminum and having a higher electron density than that of aluminum.

### CROSS-REFERENCE TO RELATED APPLICATION

This application is based on and claims priority under 35 USC 119 from Japanese Patent Application No. 2022-060242 filed on Mar. 31, 2022.

### TECHNICAL FIELD

The present invention relates to a powder metal material for additive manufacturing, which is an aluminum alloy, and an additive manufacturing method.

### BACKGROUND ART

Aluminum alloys are used, for example, in applications requiring weight reduction, such as vehicles and aircraft.

JP2018-131646A describes a technique of molding an aluminum alloy having high rigidity without containing hard particles such as ceramics by a casting method.

In addition, as a method for molding the aluminum alloy, an additive manufacturing method using an aluminum alloy powder is known (see, for example, JP2021-531398A and JP6393008B).

### SUMMARY OF INVENTION

An aluminum alloy molded body obtained by the casting method in JP2018-131646A exhibits excellent rigidity, but there is room for improvement in the viewpoint of ductility.

In addition, for example, an aluminum alloy powder in the related art, such as A110SiMg, cannot be used to produce a molded body having excellent rigidity,

The present invention provides a powder metal material for additive manufacturing, which is an aluminum alloy, from which a manufactured object having excellent rigidity and ductility can be obtained, and an additive manufacturing method using the above powder metal material.

A powder metal material according to the present invention is a powder metal material for additive manufacturing, which is an aluminum alloy containing, at least one metal atom having a smaller atomic radius and a higher electron density than aluminum.

According to the present invention, it is possible to provide a powder metal material for additive manufacturing, which is an aluminum alloy, from which a manufactured object having excellent rigidity and ductility can be obtained, and an additive manufacturing method using the above powder metal material.

### DETAILED DESCRIPTION OF THE INVENTION

Hereinafter, embodiments for carrying out the present invention will be described in detail.

### [Powder Metal Material]

A powder metal material according to the present invention is an additive manufacturing powder metal material for additive manufacturing, which is an aluminum alloy containing, at least one metal atom having a smaller atomic radius and a higher electron density than aluminum.

From the powder metal material according to the present invention, a manufactured object having excellent rigidity and ductility can be obtained.

The reason why a manufactured object having excellent rigidity and ductility can be obtained from the aluminum alloy of the powder metal material according to the present invention is not completely clear, but is considered to be that when the aluminum alloy contains at least one metal atom having a smaller atomic radius and a higher electron density than aluminum and is molded by additive manufacturing (preferably additive manufacturing using a 3D printer), intermetallic compounds of different types and shapes from those obtained by molding using a casting method are produced, whereby the rigidity and the ductility are excellent.

Examples of the metal atom having a smaller atomic radius and a higher electron density than aluminum include Fe, Co, Mo, and Ni.

In the present invention, the metal atom having a smaller atomic radius and a higher electron density than aluminum is preferably at least one selected from the group consisting of Fe, Co, Mo, and Ni. When the aluminum alloy contains at least one selected from the group consisting of Fe, Co, Mo, and Ni, the rigidity can be further improved.

The aluminum alloy of the powder metal material according to the present invention preferably further contains at least one of Ti and Zr, and more preferably Ti.

The aluminum alloy of the powder metal material according to the present invention preferably contains Ti and Zr.

When the aluminum alloy contains at least one of Ti and Zr, the rigidity and the ductility can be further improved. In particular, when Zr is contained, the ductility can be further improved.

It is preferable that the aluminum alloy of the powder metal material according to the present invention contains, in terms of mass %,
Ti: 0.1% to 3.0%,
Zr: 3.0% or less,
Co: 3.0% or less,
Si: 3,0% to 20.0%,
Cu: 0.1% to 10.0%,
Mn: 3.0% or less,
Mg: 0.1% to 3.0%,
Ni: 5.0% or less,
Cr: 1.0% or less,
Zn: 3.0% or less,
Fe: 0.05% to 5.0%,
Mo: 3.0% or less, and
Y: 3.0% or less.

Note that unless otherwise specified, the content of each alloying element is a mass-based value based on 100% of the entire aluminum alloy.

When the powder metal material according to the present invention positively contains the above impurity elements in addition to Al, which is the main constituent element of the aluminum alloy, the rigidity and the ductility can be improved. Since the powder metal material according to the present invention may positively contain impurity elements, it is preferred from the viewpoint that secondary ingots containing many impurities such as Fe and Zn, or recycled materials containing many impurities can be used as raw materials and from the viewpoint of reducing carbon dioxide emissions during production, saving resources, and reducing environmental load.

The aluminum alloy of the powder metal material according to the present invention preferably has the balance being Al and inevitable impurities in the above chemical composition.

In the aluminum alloy of the powder metal material according to the present invention, a content of Al is preferably 55 mass % or more, more preferably 60 mass % or more, still more preferably 70 mass % or more, and particularly preferably 75 mass % or more.

The inevitable impurities are components that can be inevitably mixed from raw materials or the environment during the production of the aluminum alloy in the present invention. A content of the inevitable impurities is usually 2 mass % or less.

A content of Ti in the aluminum alloy is preferably 0.1 mass % to 3.0 mass %, more preferably 0.15 mass % to 2.5 mass %, still more preferably 0.5 mass % to 2.3 mass %, and particularly preferably 1.0 mass % to 2.0 mass %.

A content of Zr in the aluminum alloy is preferably 3.0 mass % or less, more preferably 2.,5 mass % or less, and still more preferably 2.0 mass % or less. The lower limit of the content of Zr in the aluminum alloy is not particularly limited, and may be 0 mass % or more. The aluminum alloy may not contain Zr. When the aluminum alloy contains Zr, the content of Zr may be 0.5 mass % to 2.5 mass % or 1.0 mass % to 2.0 mass %.

A content of Co in the aluminum alloy is preferably 3.0 mass % or less, more preferably 2.5 mass % or less, and still more preferably 2.0 mass % or less. The lower limit of the content of Co in the aluminum alloy is not particularly limited, and may be 0 mass % or more. The aluminum alloy may not contain Co. When the aluminum alloy contains Co, the content of Co may be 0.1 mass % to 2.5 mass % or 0.5 mass % to 2.0 mass %.

A content of Si in the aluminum alloy is preferably 3.0 mass % to 20.0 mass %, more preferably 5.0 mass % to 17.0 mass %, still more preferably 7.0 mass % to 16.0 mass %, and particularly preferably 8.0 mass % to 15.0 mass %.

A content of Cu in the aluminum alloy is preferably 0.1 mass % to 10.0 mass %, more preferably 0.3 mass % to 8.0 mass %, still more preferably 1.0 mass % to 7.0 mass %, and particularly preferably 3.0 mass % to 5.0 mass %.

A content of Mn in the aluminum alloy is preferably 3.0 mass % or less, more preferably 2.5 mass % or less, and still more preferably 2.0 mass % or less. The lower limit of the content of Mn in the aluminum alloy is not particularly limited, and may be 0 mass % or more. The aluminum alloy may not contain Mn. When the aluminum alloy contains Mn, the content of Mn may be 0.03 mass % to 1.5 mass % or 0.1 mass % to 1.0 mass %.

A content of Mg in the aluminum alloy is preferably 0.1 mass % to 3.0 mass %, more preferably 0.2 mass % to 2.0 mass %, and still more preferably 0.3 mass % to 1.0 mass %.

A content of Ni in the aluminum alloy is preferably 5.0 mass % or less, more preferably 3.0 mass % or less, and still more preferably 2.0 mass % or less. The lower limit of the content of Ni in the aluminum alloy is not particularly limited, and may be 0 mass % or more. The aluminum alloy may not contain Ni. When the aluminum alloy contains Ni, the content of Ni may be 0.1 mass % to 1.5 mass % or 0.5 mass % to 1.0 mass %.

A content of Cr in the aluminum alloy is preferably 1.0 mass % or less, more preferably 0.5 mass % or less, and still more preferably 0.3 mass % or less. The lower limit of the content of Cr in the aluminum alloy is not particularly limited, and may be 0 mass % or more. The aluminum alloy may not contain Cr. When the aluminum alloy contains Cr, the content of Cr may be 0.01 mass % to 0.2 mass % or 0.03 mass % to 0.1 mass %.

A content of Zn in the aluminum alloy is preferably 3.0 mass % or less, more preferably 2.5 mass % or less, and still more preferably 2.0 mass % or less. The lower limit of the content of Zn in the aluminum alloy is not particularly limited, and may be 0 mass % or more. The aluminum alloy may not contain Zn. When the aluminum alloy contains Zn, the content of Zn may be 0.1 mass % to 1.5 mass % or 0.2 mass % to 1.0 mass %.

A content of Fe in the aluminum alloy is preferably 0.05 mass % to 5.0 mass %, more preferably 0.15 mass % to 4.0 mass %, still more preferably 0.5 mass % to 3.5 mass %, and particularly preferably 1.0 mass % to 3.0 mass %.

A content of Mo in the aluminum alloy is preferably 3.0 mass % or less, more preferably 2.0 mass % or less, and still more preferably 1.0 mass % or less. The lower limit of the content of Mo in the aluminum alloy is not particularly limited, and may be 0 mass % or more. The aluminum alloy may not contain Mo, When the aluminum alloy contains Mo, the content of Mo may be 0.01 mass % to 0.5 mass % or 0.05 mass % to 0.3 mass %.

A content of Y in the aluminum alloy is preferably 3.0 mass % or less, more preferably 2.0 mass % or less, and still more preferably 1.0 mass % or less. The lower limit of the content of Y in the aluminum alloy is not particularly limited, and may be 0 mass % or more. The aluminum alloy may not contain Y. When the aluminum alloy contains Y, the content of Y may be 0.01 mass % to 0.5 mass % or 0.05 mass % to 0.3 mass %.

The particle size of the powder metal material according to the present invention is not particularly limited. Known particle sizes suitable for additive manufacturing (preferably for manufacturing using a 3D printer) (for example, 10 μm to 200 μm of volume average particle size (D₅₀) measured with a laser diffraction particle size distribution measuring device) can be used.

A method for producing the powder metal material according to the present invention is not particularly limited, and known methods (for example, a gas atomization method, a plasma atomization method, and a centrifugal atomization method) can be used.

### [Additive Manufacturing Method]

In an additive manufacturing method according to the present invention, it is preferable to use the above powder metal material, and it is particularly preferable to use the above powder metal material in manufacturing using a 3D printer.

With the additive manufacturing method according to the present invention, a manufactured object having excellent rigidity and ductility can be obtained.

The additive manufacturing method according to the present invention is manufacturing using a 3D printer, and a cooling rate after the powder metal material is melted by laser or electron beam irradiation is higher than that in the casting method. It is considered that the ductility of the manufactured object can be improved because of the high cooling rate.

In the additive manufacturing method according to the present invention, the cooling rate after the powder metal material is melted is preferably 10³° C./sec or more, and more preferably 10⁴° C./sec or more.

As the 3D printer, a known one can be used.

The additive manufacturing method is not particularly limited, and for example, a powder bed fusion method and a direct energy deposition method are preferred.

The manufactured object produced by the additive manufacturing method according to the present invention has excellent rigidity and ductility, and thus can be used for various purposes such as automobile parts.

### EXAMPLES

Hereinafter, the present invention will be described more specifically by way of Examples and Comparative Examples, but the present invention is not limited thereto.

Aluminum alloy powders (average particle size: 40 μm) having compositions shown in Tables 1 and 2 below were prepared. In Tables 1 and 2. “Bal” indicates “balance”.

The aluminum alloy powders in Examples 1 to 5 were prepared by a gas atomization method.

As the aluminum alloy powder in Comparative Example 1, a commercially available powder was used.

The aluminum alloy powder in Comparative Example 2 was prepared by using an aluminum alloy commercially available as a general material.

The aluminum alloy powders in Examples and Comparative Examples shown in Tables 1 and 2 were subjected to additive manufacturing using a 3D printer to produce manufactured objects.

The used 3D printer had a cooling rate of 10⁵° C./sec after the aluminum alloy powder was melted.

### <Measurement of Young's Modulus>

Using each of the aluminum alloy powders in Examples and Comparative Examples in Tables 1 and 2, a rectangular sample having a width of 10 mm, a length of 60 mm, and a thickness of 1.5 mm was prepared by using a 3D printer, The Young's modulus of the prepared sample was measured by a resonance method.

The Young's modulus was measured by using a measuring device (JE-RT manufactured by Nihon Techno-Plus Co, Ltd.). Specifically, the Young's modulus was measured according to JIS Z 2280 by the method described in JP2018-131646A.

### <Measurement of Elongation>

Using each of the aluminum alloy powders in Examples and Comparative Examples in Tables 1 and 2, a JIS No. 4 test piece was prepared by using a 3D printer. A tensile test was performed on the prepared test piece at room temperature using a universal testing machine (Autograph manufactured by Shimadzu Corporation). A crosshead speed was 0.5 mm/min. The elongation (butt elongation) (%) when the test piece broke was determined.

### <Measurement of Strength>

Using each of the aluminum alloy powders in Examples and Comparative Examples in Table 2, a HS No. 4 test piece was prepared by using a 3D printer. A tensile test was performed on the prepared test piece at room temperature using a universal testing machine (Autograph manufactured by Shimadzu Corporation). A crosshead speed was 0.5 mm/min. A stress when the test piece broke was taken as the tensile strength (MPa). The results are shown in the “Strength (MPa)” column in Table 2.

TABLE 1

| | | | | | | | | | | | | Young's | |
|---|---|---|---|---|---|---|---|---|---|---|---|---|---|
| | | | | | | | | | | | | modulus | Elongation |
| mass % | Si | Cu | Mn | Mg | Zn | Fe | Ni | Cr | Zr | Ti | Al | (GPa) | (%) |
| Comparative | 10 | — | — | 0.4 | — | 0.15 | — | — | — | — | Bal | 75.7 | 6 |
| Example 1 | | | | | | | | | | | | | |
| (Al10SiMg) | | | | | | | | | | | | | |
| Example 1 | 12.8 | 4.5 | 0.1 | 0.7 | 0.25 | 1.2 | 0.9 | 0.04 | — | 0.15 | Bal | 83.5 | 3.2 |
| Example 2 | 12.8 | 4.5 | 0.1 | 0.7 | 0.25 | 0.15 | 0.9 | 0.04 | — | 0.15 | Bal | 81.3 | 3.5 |
| Example 3 | 12.2 | 3.8 | 0.4 | 0.4 | 0.8 | 1.0 | — | — | 1.26 | 1.0 | Bal | 84.2 | 4.5 |
| Example 4 | 12.2 | 3.8 | 0.4 | 0.4 | 0.8 | 1.0 | — | — | — | 1.0 | Bal | 82.1 | 4.8 |

TABLE 2

| | | | | | | | | | | | | Young's | | |
|---|---|---|---|---|---|---|---|---|---|---|---|---|---|---|
| | | | | | | | | | | | | modulus | Elongation | Strength |
| mass % | Si | Mg | Cu | Fe | Cr | Ni | Co | Ti | Zr | Sr | Al | (GPa) | (%) | (MPa) |
| Comparative | 7.0 | 0.3 | — | 0.1 | — | — | — | 0.01 | — | 0.02 | Bal | 71 | 8 | 300 |
| Example 2 | | | | | | | | | | | | | | |
| (AC4CH) | | | | | | | | | | | | | | |
| Example 5 | 7.0 | 0.4 | 0.3 | 2.9 | — | — | — | 1.2 | 1.3 | — | Bal | 84 | 7.9 | 405 |

As can be seen from Tables 1 and 2 that with the aluminum alloy powders in Examples 1 to 5, a manufactured object having a Young's modulus of 80 GPa or more, excellent rigidity, an elongation of 3% or more, and excellent ductility can be produced.

In addition, as can be seen from Table 2 that with the aluminum alloy powder in Example 5, a manufactured object having an excellent strength can be produced.

Although the embodiment of the present invention has been described above, the present invention is not limited to the above embodiment, and modifications, improvements, or the like can be made as appropriate.

In the present description, at least the following matters are described.

(1) A powder metal material for additive manufacturing, which is an aluminum alloy containing:
at least one metal atom having a smaller atomic radius and a higher electron density than aluminum.

According to (1) a manufactured object having excellent rigidity and ductility can be obtained.

(2) The powder metal material according to (1), in which the metal atom having a smaller atomic radius and a higher electron density than aluminum is at least one selected from the group consisting of Fe, Co, Mo, and Ni.

According to (2), the rigidity can be further improved.

(3) The powder metal material according to (1) or (2), in which the aluminum alloy further contains at least one of Ti and Zr.

According to (3), the rigidity and the ductility can be further improved.

(4) The powder metal material according to any one of (1) to (3), in which the aluminum alloy contains
in terms of mass %,
Ti: 0.1% to 3.0%,
Zr: 3.0% or less,
Co: 3.0% or less,
Si: 3.0% to 20.0%,
Cu: 0.1% to 10.0%,
Mn: 3.0% or less,
Mg: 0.1% to 3.0%,
Ni: 5.0% or less,
Cr: 1.0% or less,
Zn: 3.0% or less,
Fe: 0.05% to 5.0%,
Mo: 3.0% or less, and
Y: 3.0% or less.

According to (4), since impurity elements may be positively contained, it is preferred from the viewpoint that secondary ingots containing many impurities such as Fe and Zn, or recycled materials containing many impurities can be used as raw materials and from the viewpoint of reducing carbon dioxide emissions during production, saving resources, and reducing environmental load.

(5) An additive manufacturing method including:
performing manufacturing using a 3D printer by using the powder metal material according to any one of (1) to (4).

According to (5), a manufactured object having excellent rigidity and ductility can be obtained.

What is claimed is:

1. A powder metal material for additive manufacturing, which is an aluminum alloy comprising:
at least one metal atom having a smaller atomic radius and a higher electron density than aluminum.

2. The powder metal material according to claim 1, wherein the metal atom having a smaller atomic radius and a higher electron density than aluminum is at least one selected from the group consisting of Fe, Co, Mo, and Ni.

3. The powder metal material according to claim 1, wherein the aluminum alloy further contains at least one of Ti and Zr.

4. The powder metal material according to claim 2, wherein the aluminum alloy further contains at least one of Ti and Zr.

5. The powder metal material according to claim 1, wherein
the aluminum alloy contains
0.1 to 3.0 mass % of Ti,
3.0 mass % or less of Zr,
3.0 mass % or less of Co,
3,0 to 20.0 mass % of Si,
0.1 to 10.0 mass % of Cu,
3.0 mass % or less of Mn,
0.1 to 3.0 mass % of Mg,
5.0 mass % or less of Ni,
1.0 mass % or less of Cr,
3.0 mass % or less of Zn,
0.05 to 5.0 mass % of Fe,
3.0 mass % or less of Mo, and
3.0 mass % or less of Y.

6. The powder metal material according to claim 2, wherein
the aluminum alloy contains
0.1 to 3.0 mass % of Ti,
3.0 mass % or less of Zr,
3.0 mass % or less of Co,
3.0 to 20.0 mass % of Si,
0.1 to 10.0 mass % of Cu,
3.0 mass % or less of Mn,
0.1 to 3,0 mass % of Mg,
5.0 mass % or less of Ni,
1.0 mass % or less of Cr,
3.0 mass % or less of Zn,
0.05 to 5.0 mass % of Fe,
3.0 mass % or less of Mo, and
3.0 mass % or less of Y.

7. The powder metal material according to claim 3, where
the aluminum alloy contains
0.1 to 3.0 mass % of Ti,
3.0 mass % or less of Zr,
3.0 mass % or less of Co,
3.0 to 20.0 mass % of Si,
0.1 to 10.0 mass % of Cu,
3.0 mass % or less of Mn,
0.1 to 3.0 mass % of Mg,
5.0 mass % or less of Ni,
1.0 mass % or less of Cr,
3.0 mass % or less of Zn,
0.05 to 5.0 mass % of Fe,
3,0 mass % or less of Mo, and
3.0 mass % or less of Y.

8. The powder metal material according to claim 4, wherein
the aluminum alloy contains
0.1 to 3.0 mass % of Ti,
3.0 mass % or less of Zr,
3.0 mass % or less of Co,
3.0 to 20.0 mass % of Si,
0.1 to 10.0 mass % of Cu,
3.0 mass % or less of Mn,
0.1 to 3.0 mass % of Mg,
5.0 mass % or less of Ni,
1.0 mass % or less of Cr,
3.0 mass % or less of Zn,
0.05 to 5.0 mass % of Fe,
3.0 mass % or less of Mo, and
3.0 mass % or less of Y.

9. An additive manufacturing method comprising:
performing manufacturing using a 3D printer by using the powder metal material according to claim 1.

10. An additive manufacturing method comprising:
performing manufacturing using a 3D printer by using the powder metal material according to claim 2.

11. An additive manufacturing method comprising:
performing manufacturing using a 3D printer by using the powder metal material according to claim 3.

12. An additive manufacturing method comprising:
performing manufacturing using a 3D printer by using the powder metal material according to claim 4.

13. An additive manufacturing method comprising:
performing manufacturing using a 3D printer by using the powder metal material according to claim 5.

14. An additive manufacturing method comprising:
performing manufacturing using a 3D printer by using the powder metal material according to claim 6.

15. An additive manufacturing method comprising:
performing manufacturing using a 3D printer by using the powder metal material according to claim 7.

16. An additive manufacturing method comprising:
performing manufacturing using a 3D printer by using the powder metal material according to claim 8.
